(19) United States
(12) Patent Application Publication
(10) Pub. No.: US 2011/0261771 A1
(43) Pub. Date: Oct. 27, 2011

(54) RADIO BASE STATION APPARATUS AND MOBILE TERMINAL APPARATUS

(75) Inventors: Satoshi Nagata, Kanagawa (JP); Yoshihisa Kishiyama, Kanagawa (JP); Motohiro Tanno, Kanagawa (JP); Mamoru Sawahashi, Kanagawa (JP)

(73) Assignee: NTT DOCOMO, INC., Tokyo (JP)

(21) Appl. No.: 13/126,725

(22) PCT Filed: Oct. 30, 2009
(86) PCT No.: PCT/JP2009/068672

§ 371 Date: Jul. 7, 2011

(30) Foreign Application Priority Data
Nov. 4, 2008 (JP) 2008-283756
Jul. 31, 2009 (JP) 2009-179826

(51) Int. Cl. H04W 84/00; H04B 7/24

(52) U.S. Cl. 370/329; 455/507

(57) ABSTRACT

The present invention provides a radio base station apparatus and a mobile terminal apparatus compatible with respective mobile communication systems when a plurality of mobile communication systems coexist. The mobile terminal apparatus performs a cell search using a synchronization channel signal specific to a first mobile communication system made up of a plurality of component carriers multiplexed with at least one downlink component carrier in the first mobile communication system and/or a synchronization channel signal for a second mobile communication system having a relatively narrow second system band multiplexed with at least one downlink component carrier in the first mobile communication system. and makes random access using uplink/downlink component carriers allocated based on information of downlink component carriers including the synchronization channel signal used for the cell search and information of uplink component carriers included in a dynamic broadcast channel signal broadcast from the radio base station apparatus.

### TECHNICAL FIELD

The present invention relates to a radio base station apparatus and a mobile terminal apparatus in a next-generation mobile communication system.

### BACKGROUND ART

UMTS (Universal Mobile Telecommunications System) networks are making the most of the features of a W-CDMA (Wideband Code Division Multiple Access) based system by adopting HSDPA (High Speed Downlink Packet Access) and HSUPA (High Speed Uplink Packet Access) aiming at improving frequency utilization efficiency and improving data rates. For these UMTS networks, Long Term Evolution (LTE) is under study for the purpose of realizing higher data rates and lower delays or the like (Non-Patent Document 1). As a multiplexing scheme, LTE uses OFDMA (Orthogonal Frequency Division Multiple Access) which is different from W-CDMA for a downlink and SC-FDMA (Single Carrier Frequency Division Multiple Access) for an uplink.

Third-generation systems can generally realize a transmission rate on the order of maximum 2 Mbps on a downlink using a fixed band of 5 MHz. On the other hand, LTE systems can realize a transmission rate of maximum 300 Mbps on a downlink and on the order of 75 Mbps on an uplink using a variable band of 1.4 MHz to 20 MHz. In the UMTS networks, successor systems of LTE are also under study for the purpose of realizing wider bands and higher speeds (e.g., LTE Advanced (LTE-A)). Therefore, a plurality of such mobile communication systems are expected to coexist in the future and a configuration (radio base station apparatus and mobile terminal apparatus or the like) capable of supporting such a plurality of systems may be necessary.

### CITATION LIST

### Non-Patent Literature

Non-Patent Literature 1: 3GPP, TR25.912 (V7.1.0), “Feasibility study for Evolved UTRA and UTRAN”, September 2006

### SUMMARY OF INVENTION

### Technical Problem

The present invention has been implemented in view of the above-described circumstances and it is therefore an object of the present invention to provide, when a plurality of mobile communication systems coexist, a radio base station apparatus and a mobile terminal apparatus supporting the respective mobile communication systems.

### Solution to the Problem

A radio base station apparatus according to the present invention is provided with synchronization channel signal generating section configured to generate, for at least one downlink component carrier in a first mobile communication system having a relatively wide first system band composed of a plurality of component carriers, a synchronization channel signal specific to the first mobile communication system and generate a synchronization channel signal for a second mobile communication system having a relatively narrow second system band for another downlink component carrier with which the synchronization channel signal specific to the first mobile communication system is not multiplexed, and transmitting section configured to transmit a control signal including the synchronization channel signal.

Furthermore, a radio base station apparatus of the present invention is provided with synchronization channel signal generating section configured to generate, for at least one downlink component carrier in a first mobile communication system having a relatively wide first system band composed of a plurality of component carriers, a synchronization channel signal for a second mobile communication system having a relatively narrow second system band and generate no synchronization channel signal for other downlink component carriers, and transmitting section configured to transmit a control signal including the synchronization channel signal.

A mobile terminal apparatus of the present invention is provided with cell search section configured to perform a cell search using a synchronization channel signal specific to a first mobile communication system having a relatively wide first system band compopsed of a plurality of component carriers, which the synchronization channel signal specific to a first mobile communication system is multiplexed with at least one downlink component carrier in the first mobile communication system, and central frequency controlling section configured to control a reception central frequency of a downlink signal based on information of the downlink component carrier including the cell-searched synchronization channel signal specific to the first mobile communication system.

Furthermore, a mobile terminal apparatus of the present invention is provided with cell search section configured to perform a cell search using a synchronization channel signal for a second mobile communication system having a relatively narrow second system band, which the synchronization channel signal for a second mobile communication system is multiplexed with at least one downlink component carrier in a first mobile communication system having a relatively wide first system band composed of a plurality of component carriers, and central frequency controlling section configured to control a reception central frequency of a downlink signal based on information of a downlink component carrier including the cell-searched synchronization channel signal for the second mobile communication system.

### Technical Advantage of the Invention

In the present invention, the mobile terminal apparatus performs a cell search, in a first mobile communication system having a relatively wide first system band made up of a plurality of component carriers, using a synchronization channel signal specific to the first mobile communication system multiplexed with at least one downlink component carrier and/or a synchronization channel signal for a second mobile communication system having a relatively narrow second system band multiplexed with at least one downlink component carrier in the first mobile communication system having the relatively wide first system band made up of a plurality of component carriers, then performs random access with uplink/downlink component carriers allocated based on information of downlink component carriers including the synchronization channel signal used for the cell search and information of uplink component carriers included in the broadcast information broadcast from the radio base station apparatus, and therefore even when a plurality of mobile communication systems coexist, it is possible to support the respective mobile communication systems. Particularly, it is possible to make initial access by shortening a control delay between the radio base station apparatus and the mobile terminal apparatus in accordance with the respective mobile communication systems.

### BRIEF DESCRIPTION OF DRAWINGS

FIG. 1 is a diagram illustrating a system band of an LTE system;

FIG. 2 is a diagram illustrating asymmetry in frequency band between a downlink and an uplink;

FIG. 3 is a diagram illustrating a schematic configuration of a radio base station apparatus according to an embodiment of the present invention;

FIGS. 4(a) and (b) are diagrams illustrating downlink component carriers to which a synchronization channel signal and a broadcast channel signal are allocated;

FIG. 5 is a diagram illustrating a schematic configuration of a mobile terminal apparatus according to the embodiment of the present invention;

FIG. 6 is a diagram illustrating a procedure for initial access according to the present invention;

FIG. 7 is a diagram illustrating another example of procedure for initial access according to the present invention;

FIG. 8 is a diagram illustrating pair band allocation of uplink CC and downlink CC according to the present invention;

FIG. 9 is a diagram illustrating another example of initial access procedure according to the present invention; and

FIG. 10 is a diagram illustrating pair band allocation according to the present invention.

### DESCRIPTION OF EMBODIMENTS

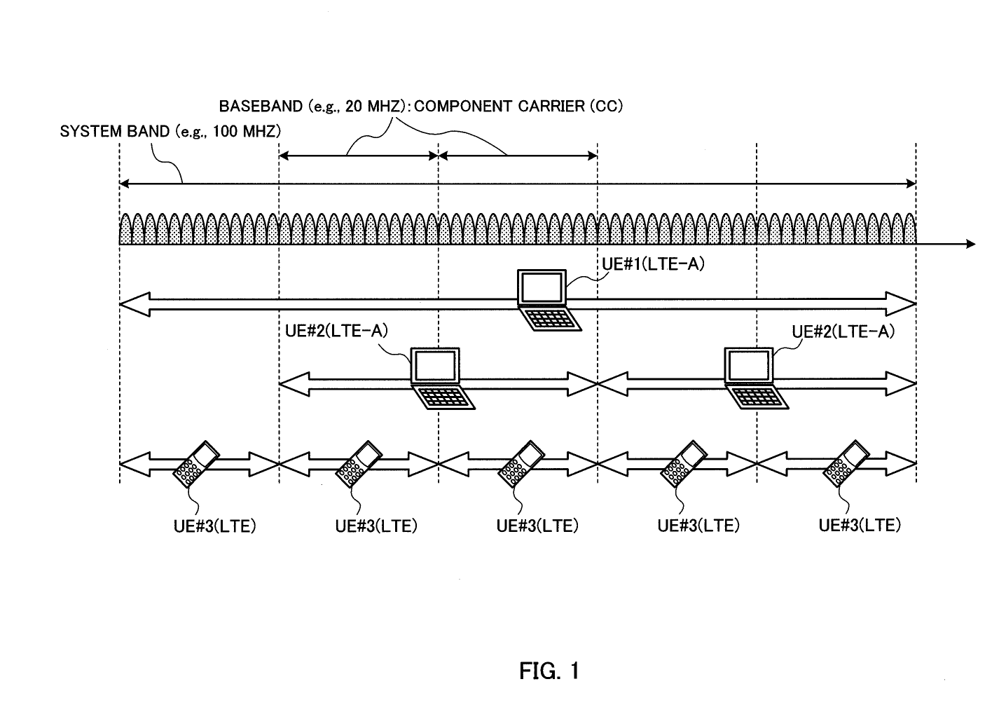

FIG. 1 is a diagram illustrating a state of frequency usage when mobile communication is performed on a downlink. The example shown in FIG. 1 illustrates a state of frequency usage when an LTE-A system which is a first mobile communication system having a relatively wide first system band composed of a plurality of component carriers and an LTE system which is a second mobile communication system having a relatively narrow (here, composed of one component carrier) second system band coexist. The LTE-A system performs radio communication using a variable system bandwidth of 100 MHz or less and the LTE system performs radio communication using a variable system bandwidth of 20 MHz or less. The system band of the LTE-A system is at least one fundamental frequency domain (component carrier: CC) assuming the system band of the LTE system as one unit. Band broadening by uniting a plurality of fundamental frequency domains is called “carrier aggregation.”

For example, in FIG. 1, the system band of the LTE-A system is a system band (20 MHz×5=100 MHz) including five component carrier bands, each component carrier being compopsed of the system band (baseband: 20 MHz) of the LTE system. In FIG. 1, a mobile terminal apparatus UE (User Equipment) #1 is a mobile terminal apparatus supporting the LTE-A system (also supporting the LTE system) and has a system band of 100 MHz, UE #2 is a mobile terminal apparatus supporting the LTE-A system (also supporting the LTE system) and has a system band of 40 MHz (20 MHz×2=40 MHz) and UE #3 is a mobile terminal apparatus supporting the LTE system (not supporting the LTE-A system) and has a system band of 20 MHz (baseband).

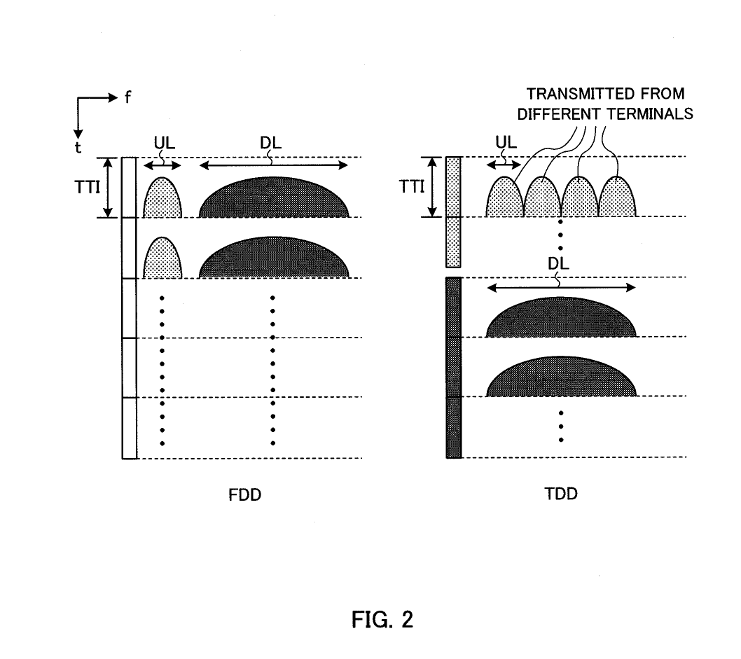

In radio communication in frequency bands broadened in this way, a frequency band allocated to a downlink may be estimated to be asymmetric to a frequency band al located to an uplink. For example, in frequency division duplex (FDD) as shown in FIG. 2, an uplink (UL) and a downlink (DL) have asymmetric bandwidths at one transmission time interval (TTI), while in time division duplex (TDD), a plurality of uplinks are allocated to downlink bandwidths, that is, an uplink (UL) and a downlink (DL) have asymmetric bandwidths.

The processing procedure used in the LTE system is thus not supporting a system in which the uplink (UL) and downlink (DL) have asymmetric bandwidths. Thus, even a system capable of using a broadened frequency band can only support the fundamental frequency domain but cannot effectively utilize the broadened frequency band.

The present inventor et al. noted the following: Assuming that the LTE-A system makes initial access using a method similar to that of the LTE system, a synchronization channel (SCH) signal and a broadcast channel (BCH) signal used in the LTE system are multiplexed with each component carrier. When performing a cell search using the synchronization channel signal, a mobile terminal apparatus searches the synchronization channel signal while scanning frequencies, for example, scanning from a low frequency side to a high frequency side. For this reason, when the synchronization channel signal used in the LTE system is multiplexed with each component carrier, all cell searches are performed with the synchronization channel signal of the first scanned component carrier and the component carrier is always detected. Therefore, in the stage in which communication starts, the frequency may be shifted from the component carrier detected by the cell search to a different component carrier. In order for the mobile terminal apparatus to shift the frequency to a different component carrier, it is necessary to report information as to which component carrier the frequency is shifted from the radio base station apparatus to the mobile terminal apparatus using control information. Examples of this control information include RRC (Radio Resource Control) signaling. When information as to which component carrier the frequency is shifted is reported using control information, a control delay between the radio base station apparatus and the mobile terminal apparatus may be assumed to increase.

Therefore, the present inventor et al. came up with the present invention to solve this problem. That is, an essence of the present invention is that the mobile terminal apparatus performs a cell search, in a first mobile communication system having a relatively wide first system band composed of a plurality of component carriers, using a synchronization channel signal specific to the first mobile communication system multiplexed with at least one downlink component carrier and/or a synchronization channel signal for a second mobile communication system having a relatively narrow second system band multiplexed with one downlink component carrier in the first mobile communication system having the relatively wide first system band composed of a plurality of component carriers, then performs random access with uplink/downlink component carriers allocated based on information of downlink component carriers including the synchronization channel signal used for the cell search and information of uplink component carriers included in the broadcast information broadcast from the radio base station apparatus to thereby support the respective mobile communication systems even when a plurality of mobile communication systems coexist and make initial access by shortening a control delay between the radio base station apparatus and the mobile terminal apparatus in accordance with the respective mobile communication systems.

Hereinafter, an embodiment of the present invention will be described in detail with reference to the accompanying drawings. Here, a case will be described where a mobile terminal apparatus supporting an LTE-A system is used.

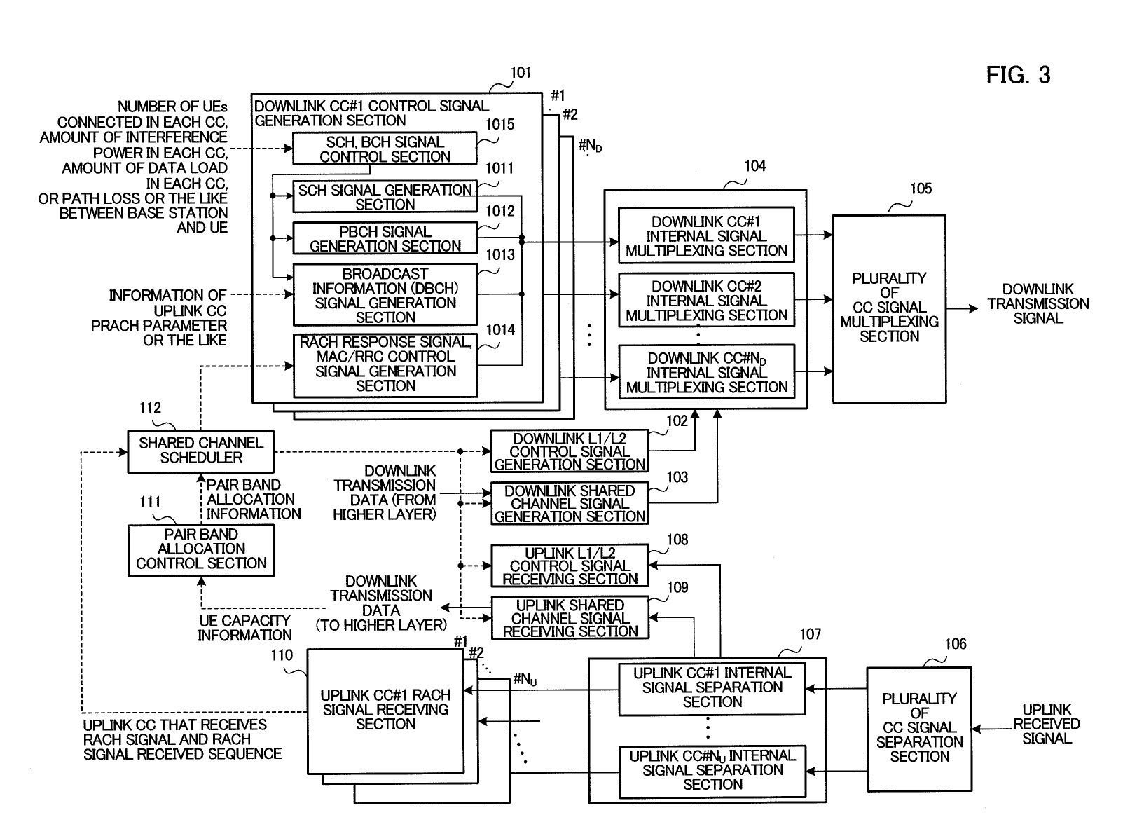

FIG. 3 is a block diagram illustrating a configuration of a radio base station apparatus according to the present embodiment. The radio base station apparatus shown in FIG. 3 is provided with a transmitting system processing section and a receiving system processing section. The transmitting system processing section includes a control signal generation section 101 that generates a downlink component carrier (downlink CC) control signal, a downlink L1/L2 control signal generation section 102 that generates a downlink control signal (layer 1/layer 2 control signal), a downlink shared channel signal generation section 103 that generates a downlink shared channel signal, a downlink CC internal signal multiplexing section 104 that multiplexes downlink CC internal signal (control signal, downlink L1/L2 control signal, downlink shared channel signal) per downlink CC and a plurality of CC signal multiplexing section 105 that multiplexes the respective multiplexed downlink CC signals. The control signal generation section 101 includes an SCH signal generation section 1011 that generates an SCH signal (synchronization channel signal) for each CC, a PBCH signal generation section 1012 that generates a PBCH signal (broadcast channel signal), a DBCH signal generation section 1013 that generates a broadcast information (Dynamic Broadcast Channel: DBCH) signal, an RACH response signal, MAC/RRC control signal generation section 1014 that generates an RACH (Random Access Channel) response signal, control signal (MAC (Media Access Control)/RRC signal) and an SCH, BCH signal control section 1015 that controls generation of the SCH signal, PBCH signal and DBCH signal generated according to a propagation environment between the radio base station apparatus and the mobile terminal apparatus.

The receiving system processing section includes a plurality of CC signal separation section 106 that separates an uplink received signal into a plurality of CC signals, an uplink CC internal signal separation section 107 that separates the individual uplink CC internal signals, an uplink L1/L2 control signal receiving section 108 that receives an uplink control signal (layer 1/layer 2 control signal), an uplink shared channel signal receiving section 109 that receives an uplink shared channel signal and an uplink CCRACH receiving section 110 that receives each uplink CC RACH signal.

Furthermore, the radio base station apparatus includes a pair band allocation control section 111 that controls allocation of downlink component carriers and uplink component carriers (pair band) from capacity information of the mobile terminal apparatus and a shared channel scheduler 112 that schedules shared channels including pair band allocation information.

The SCH signal generation section 1011 generates a synchronization channel signal for the mobile terminal apparatus to perform a cell search. The SCH signal generated by the SCH signal generation section 1011 is multiplexed with another signal by the downlink CC internal signal multiplexing section 104.

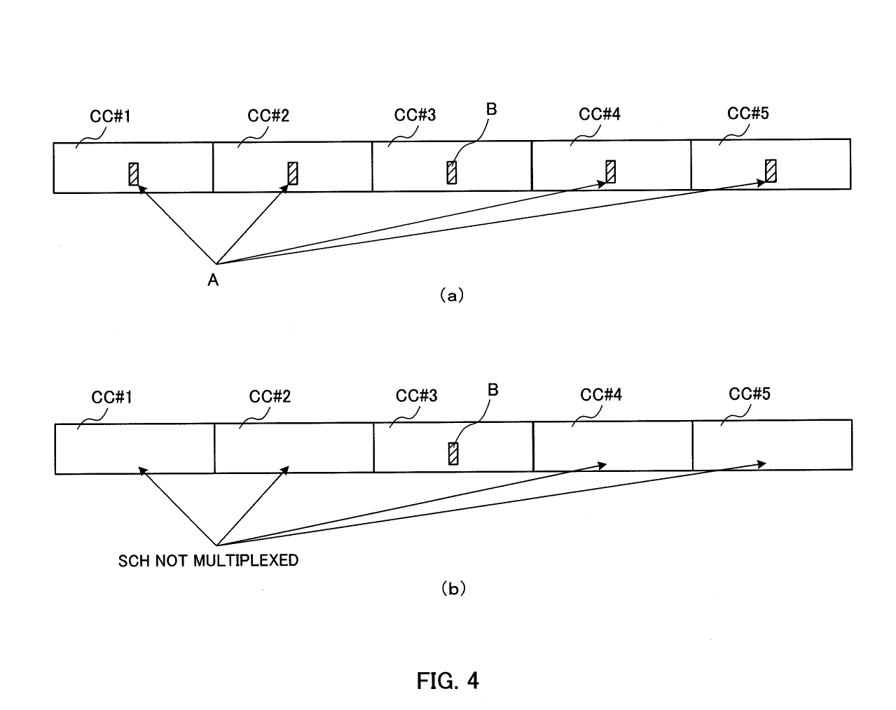

The SCH signal generation section 1011 generates a synchronization channel signal specific to an LTE-A system for at least one downlink CC in an LTE-A system and generates a synchronization channel signal for an LTE system for an other downlink CC with which a synchronization channel signal specific to an LTE-A system is not multiplexed. That is, as shown in FIG. 4(a), an SCH signal A specific to an LTE-A system is multiplexed with at least one CC and an SCH signal B for an LTE system is multiplexed with the other CC with which the SCH signal A specific to an LTE-A system is not multiplexed.

Although a case is described in FIG. 4(a) where the SCH signal A specific to an LTE-A system is multiplexed with all CCs (CC#1, CC#2, CC#4, CC#5) other than a CC (CC#3) with which the SCH signal B for an LTE system is multiplexed, the present invention is not limited to this, but the SCH signal A specific to an LTE-A system needs only to be multiplexed with at least one CC other than the CC with which the SCH signal B for an LTE system is multiplexed. Furthermore, although a case is described in FIG. 4(a) where the SCH signal B for an LTE system is multiplexed with CC#3, the present invention is not limited to this, but the SCH signal B for an LTE system may also be multiplexed with any CC.

An SCH signal specific to an LTE-A system is an SCH signal for which a mobile terminal apparatus supporting an LTE system cannot perform a cell search. Examples of such an SCH signal B include an SCH signal having a configuration/sequence different from that of an SCH signal B for an LTE system (to be more specific, SCH signal with a different zad-off sequence type), an SCH signal mapped to a time position different from that of an SCH signal B for an LTE system, an SCH signal mapped to a frequency position different from that of an SCH signal B for an LTE system and an SCH signal multiplied by a scramble sequence specific to an LTE-A system.

Furthermore, the SCH signal generation section 1011 generates a synchronization channel signal for an LTE system for at least one downlink CC in an LTE-A system and generates no synchronization channel signal for other downlink CCs. That is, as shown in FIG. 4(b), the SCH signal generation section 1011 multiplexes the SCH signal B for an LTE system with at least one (here, one) downlink CC (CC#3) and generates no SCH signal for other downlink CCs (CC#1, CC#2, CC#4, CC#5). Although a case is described in FIG. 4(b) where the SCH signal B for an LTE system is multiplexed with CC#3, the present invention is not limited to this, but the SCH signal B for an LTE system may be multiplexed with any CC or may be multiplexed with a plurality of CCs.

The PBCH signal generation section 1012 generates a broadcast channel signal (PBCH signal) including information such as bandwidth of CC and number of antennas, bandwidth of CC that DBCH can receive (accessible CC) and central frequency. The PBCH signal generated is multiplexed with other signals by the downlink CC internal signal multiplexing section 104.

The PBCH signal generation section 1012 generates a broadcast channel signal specific to an LTE-A system for at least one downlink CC in an LTE-A system and also generates a broadcast channel signal for an LTE system for an other downlink CC with which the broadcast channel signal specific to an LTE-A system is not multiplexed. That is, as shown in FIG. 4(a), the PBCH signal A specific to an LTE-A system is multiplexed with at least one CC and the PBCH signal B for an LTE system is multiplexed with the other CC with which the PBCH signal A specific to an LTE-A system is not multiplexed.

Although a case is described in FIG. 4(a) where the PBCH signal A specific to an LTE-A system is multiplexed with all CCs (CC#1, CC#2, CC#4, CC#5) other than the CC (CC#3) with which the PBCH signal B for an LTE system is multiplexed, the present invention is not limited to this, but the PBCH signal A specific to an LTE-A system needs only to be multiplexed with at least one CC other than the CC with which the PBCH signal B for an LTE system is multiplexed. Furthermore, although a case is described in FIG. 4(a) where the PBCH signal B for an LTE system is multiplexed with CC#3, the present invention is not limited to this, but the PBCH signal B for an LTE system may be multiplexed with any CC.

A PBCH signal specific to an LTE-A system is a PBCH signal which a mobile terminal apparatus supporting an LTE system cannot receive. Examples of such a PBCH signal B include a PBCH signal having a configuration/sequence different from that of the PBCH signal B for an LTE system, PBCH signal mapped to a time position different from that of the PBCH signal B for an LTE system, PBCH signal mapped to a frequency position different from that of the PBCH signal B for an LTE system and PBCH signal multiplied by a scramble sequence specific to an LTE-A system.

The DBCH signal generation section 1013 generates information of an uplink CC forming a pair with a downlink CC (initial downlink CC) (bandwidth and central frequency of paired uplink CC, bandwidth and central frequency of accessible CC or the like) as a DBCH signal (broadcast channel signal). Furthermore, the DBCH signal generation section 1013 generates carrier aggregation information of an initial downlink CC (total bandwidth of the aggregated CC or the number of aggregated CCs and central frequency thereof), RACH parameter specific to a mobile terminal apparatus supporting LTE-A and/or central frequency of CC through which paging information specific to a mobile terminal apparatus supporting LTE-A is transmitted as a DBCH signal (broadcast channel signal). The DBCH signal generated is multiplexed with other signals by the downlink CC internal signal multiplexing section 104.

The RACH response signal, MAC/RRC control signal generation section 1014 generates an RACH response signal which is a response signal of an RACH signal (preamble) and a control signal (MAC/RRC control signal). In this case, the control signal includes pair band allocation information of a downlink CC and an uplink CC sent from the shared channel scheduler 112. The RACH response signal and MAC/RRC control signal generated are multiplexed with other signals by the downlink CC internal signal multiplexing section 104.

The SCH, BCH signal control section 1015 is control signal allocating means for allocating a downlink component carrier that multiplexes a synchronization channel signal specific to an LTE-A system and/or broadcast channel signal, or allocating a downlink component carrier with which a synchronization channel signal and/or broadcast channel signal are/is not multiplexed. That is, the SCH, BCH signal control section 1015 determines with which CC an SCH or BCH (PBCH) specific to an LTE-A system is multiplexed or with which CC an SCH or BCH (PBCH) is not multiplexed (SCH or BCH (PBCH) is not transmitted). Thus, the radio base station apparatus can arbitrarily determine with which CC an SCH or BCH specific to an LTE-A system is multiplexed and/or with which CC an SCH or BCH is not multiplexed.

As for a CC to which a synchronization channel signal and/or broadcast channel signal is allocated, a predetermined CC may be always used or may be adaptively controlled according to the propagation environment between the radio base station apparatus and the mobile terminal apparatus. In this case, it is preferable to change a CC to be adaptively allocated based on the number of mobile terminals connected in each component carrier, amount of interference power in each component carrier, amount of data load in each component carrier and/or path loss (distance attenuation) between the radio base station apparatus and the mobile terminal apparatus. When a CC to be adaptively allocated is changed in this way, the radio base station apparatus may perform control in an autonomous-decentralized manner.

The downlink L1/L2 control signal generation section 102 generates a downlink L1/L2 control signal based on a schedule determined by the shared channel scheduler 112. The generated downlink L1/L2 control signal is multiplexed with other signals by the downlink CC internal signal multiplexing section 104. The downlink shared channel signal generation section 103 generates a downlink shared channel signal using downlink transmission data from a higher layer based on a schedule determined by the shared channel scheduler 112. The downlink shared channel signal generated is multiplexed with other signals by the downlink CC internal signal multiplexing section 104.

The uplink L1/L2 control signal receiving section 108 receives the uplink L1/L2 control signal separated by the uplink CC internal signal separation section 107 based on the schedule determined by the shared channel scheduler 112. The uplink shared channel signal receiving section 109 receives the uplink shared channel signal separated by the uplink CC internal signal separation section 107 based on the schedule determined by the shared channel scheduler 112. This uplink shared channel signal includes information of the transmission/reception bandwidth of the mobile terminal apparatus in an uplink CC forming a pair with the initial downlink CC including the synchronization channel signal used for a cell search. Of the uplink shared channel signal, the uplink transmission data is sent to a higher layer and information of the transmission/reception bandwidth (UE capacity information) is sent to the pair band allocation control section 111.

The pair band allocation control section 111 generates pair band allocation information of the uplink CC and downlink CC based on UE capacity information and sends the pair band allocation information to the shared channel scheduler 112. When, for example, the transmission/reception bandwidth of the mobile terminal apparatus that allocates a pair band with the UE capacity information is 40 MHz, the pair band allocation control section 111 sets the uplink CC to 40 MHz and determines the downlink CC to be a predetermined bandwidth (e.g., 60 MHz) and determines the pair band of the uplink CC and downlink CC (pair band allocation).

The shared channel scheduler 112 schedules transmission/reception of the uplink/downlink control signal and uplink/downlink shared channel. Furthermore, the shared channel scheduler 112 sends the pair band allocation information to the RACH response signal, MAC/RRC control signal generation section 1014.

The uplink CCRACH signal receiving section 110 receives an RACH signal of each CC separated by the uplink CC internal signal separation section 107. This RACH signal includes identification information of an LTE-A system. The uplink CCRACH signal receiving section 110 sends the uplink CC with which the RACH signal is received and RACH signal reception sequence together with an RACH parameter to the shared channel scheduler 112. The shared channel scheduler 112 uses the information of the uplink CC with which the RACH signal is received and RACH signal reception sequence to identify the initial downlink CC and schedules transmission/reception of the uplink/downlink shared channel signal and uplink/downlink control signal.

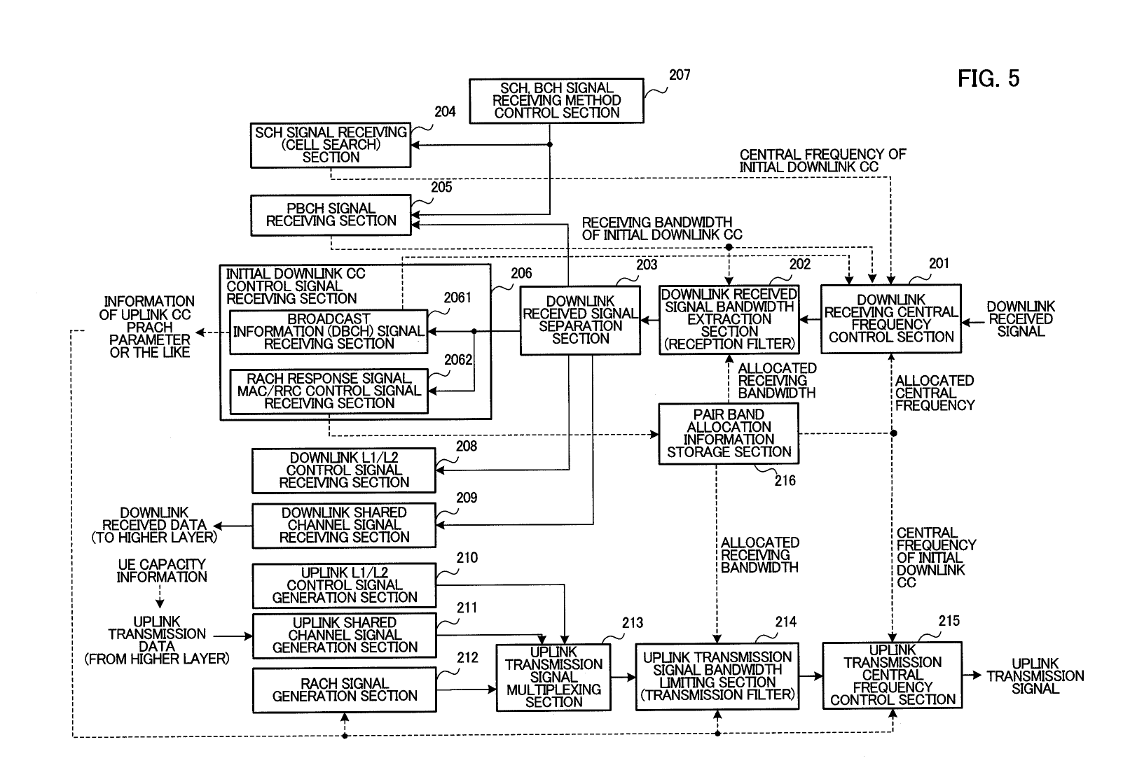

FIG. 5 is a block diagram illustrating a configuration of a mobile terminal apparatus according to the present embodiment. The mobile terminal apparatus shown in FIG. 5 is provided with a receiving system processing section and a transmitting system processing section. The receiving system processing section includes a downlink reception central frequency control section 201 that controls a downlink reception central frequency, a downlink received signal bandwidth extraction section 202 which is a reception filter that extracts a bandwidth of a downlink received signal, a downlink received signal separation section 203 that separates the downlink received signal, an SCH signal receiving section (cell search section) 204 that receives a synchronization channel signal, a PBCH signal receiving section 205 that receives a PBCH signal, an initial downlink CC control signal receiving section 206 that receives a control signal of an initial CC, an SCH/BCH signal receiving method control section 207 that controls the receiving method of an SCH signal and/or BCH signal, a downlink L1/L2 control signal receiving section 208 that receives a downlink L1/L2 control signal and a downlink shared channel signal receiving section 209 that receives a downlink shared channel signal. The initial downlink CC control signal receiving section 206 includes a DBCH signal receiving section 2061 that receives a broadcast information (DBCH) signal and an RACH response signal, MAC/RRC control signal receiving section 2062 that receives an RACH response signal and control signal (MAC/RRC signal).

The transmitting system processing section includes an uplink L1/L2 control signal generation section 210 that generates an uplink control signal, an uplink shared channel signal generation section 211 that generates an uplink shared channel signal, an RACH signal generation section 212 that generates a random access channel (RACH) signal, an uplink transmission signal multiplexing section 213 that multiplexes an uplink transmission signal, an uplink transmission signal bandwidth limiting section 214 which is a transmission filter that limits the bandwidth of the uplink transmission signal and an uplink transmission central frequency control section 215 that controls an uplink transmission central frequency.

Furthermore, the mobile terminal apparatus includes a pair band allocation information storage section 216 that stores allocation information of a downlink component carrier and an uplink component carrier (pair band).

The downlink reception central frequency control section 201 receives information of the central frequency of the downlink component carrier (initial downlink CC) when the SCH signal receiving section 204 performs a cell search from the SCH signal receiving section 204 and controls (moves) the downlink reception central frequency based on the information of the central frequency. Furthermore, the downlink reception central frequency control section 201 controls (moves) the downlink reception central frequency based on the allocation information of a downlink CC and uplink CC. The information of the controlled downlink reception central frequency is sent to the downlink received signal bandwidth extraction section 202. Furthermore, the downlink reception central frequency control section 201 receives information of the central frequency of an accessible CC in the PBCH signal from the PBCH signal receiving section 205 and controls (moves) the downlink reception central frequency based on the information of the central frequency thereof. Furthermore, the downlink reception central frequency control section 201 receives the information of the central frequency of an accessible CC in the DBCH signal from the DBCH signal receiving section 2061 and controls (moves) the downlink reception central frequency based on the information of the central frequency thereof.

The downlink received signal bandwidth extraction section 202 extracts the bandwidth of the downlink received signal based on the information of the bandwidth of the initial downlink CC of the initial downlink CC information received by the PBCH signal receiving section 205 and included in the broadcast channel signal (PBCH signal), that is, the information of the bandwidth and the number of antennas of the initial downlink CC. The received signal filtered in this way is sent to the downlink received signal separation section 203. Furthermore, the downlink received signal bandwidth extraction section 202 extracts the bandwidth of the downlink received signal based on the allocation information of the downlink CC and uplink CC. To be more specific, the received signal is filtered using a reception filter set to the bandwidth of the initial downlink CC (or accessible CC) using the downlink reception central frequency.

The downlink received signal separation section 203 separates the downlink received signal into an SCH signal, BCH signal (PBCH signal, DBCH signal), downlink control signal (L1/L2 control signal) and downlink shared channel signal. The downlink received signal separation section 203 then sends the PBCH signal to the PBCH signal receiving section 205, sends the downlink L1/L2 control signal to the downlink L1/L2 control signal receiving section 208, and outputs the downlink shared channel signal to the downlink shared channel signal receiving section 209. The downlink shared channel signal outputted to the downlink shared channel signal receiving section 209 is sent to a higher layer as downlink received data. Upon receiving an initial downlink CC control signal as the downlink received signal in initial access, the downlink received signal separation section 203 separates the signal into the broadcast information signal (DBCH signal), the RACH response signal and the MAC/RRC control signal. The downlink received signal separation section 203 sends the broadcast information signal (DBCH signal) to the DBCH signal receiving section 2061 and outputs the RACH response signal, MAC/RRC control signal to the RACH response signal, MAC/RRC control signal receiving section 2062.

The SCH signal receiving section 204 performs a cell search using an SCH signal included in any one of a plurality of downlink CCs. When there are downlink CCs that multiplex an SCH signal A specific to an LTE-A system and downlink CCs that multiplex an SCH signal B for an LTE system as shown in FIG. 4(a), the SCH signal receiving section 204 may also perform a cell search using the SCH signal A specific to an LTE-A system or may perform a cell search using the SCH signal B for an LTE system or may perform a cell search using both the SCH signal A specific to an LTE-A system and the SCH signal B for an LTE system. When a cell search is performed using both the SCH signal A specific to an LTE-A system and the SCH signal B for an LTE system, it may be possible to perform a carrier search at a frequency raster interval from, for example, a lower carrier frequency and stop the carrier search when any one SCH signal is received with a certain CC or perform a carrier search at a frequency raster interval from, for example, a lower carrier frequency and sequentially receive a plurality of SCH signals of a plurality of CCs.

On the other hand, when there are downlink CCs that multiplex the SCH signal B for an LTE system and downlink CCs that do not multiplex any SCH signal as shown in FIG. 4(b), the SCH signal receiving section 204 performs a cell search using the SCH signal B for an LTE system. In a cell search when the SCH signal B for an LTE system is multiplexed with a plurality of CCs, it may be possible to perform a carrier search at a frequency raster interval from, for example, a lower carrier frequency and stop the carrier search when an SCH signal is received with a certain CC or perform a carrier search at a frequency raster interval from, for example, a lower carrier frequency and sequentially receive a plurality of SCH signals of a plurality of CCs.

In a cell search, it depends on an instruction from the SCH/BCH signal receiving method control section 207 which SCH signal should be used. A frequency block including an SCH signal for which the SCH signal receiving section 204 performs a cell search is assumed to be an initial downlink CC. The SCH signal receiving section 204 then feeds back information of the central frequency of the initial downlink CC to the downlink reception central frequency control section 201.

The PBCH signal receiving section 205 receives a PBCH signal included in any one of a plurality of downlink CCs. As shown in FIG. 4(a), when there are downlink CCs that multiplex a PBCH signal A specific to an LTE-A system and downlink CCs that multiplex a PBCH signal B for an LTE system, the PBCH signal receiving section 205 may receive the PBCH signal A specific to an LTE-A system, may receive the PBCH signal B for an LTE system or may receive both the PBCH signal A specific to an LTE-A system and the PBCH signal B for an LTE system. On the other hand, as shown in FIG. 4(b), when there are downlink CCs that multiplex a PBCH signal B for an LTE system and downlink CCs that do not multiplex any PBCH signal, the PBCH signal receiving section 205 receives the PBCH signal B for an LTE system.

It depends on an instruction from the SCH/BCH signal receiving method control section 207 how the PBCH signal should be received. Of the initial downlink CC information included in the PBCH signal, that is, information such as bandwidth, number of antennas of the initial downlink CC, the PBCH signal receiving section 205 extracts information of the bandwidth of the initial downlink CC and outputs the information to the downlink received signal bandwidth extraction section 202. Furthermore, since the PBCH signal includes information (central frequency or the like) on CCs that DBCH can receive (accessible CCs), the PBCH signal receiving section 205 extracts the information of accessible CCs from the PBCH signal and outputs the information to the downlink reception central frequency control section 201.

The DBCH signal receiving section 2061 receives a broadcast information signal (DBCH) including uplink CC information (bandwidth and intermediate frequency) forming a pair with the initial downlink CC including the cell-searched SCH signal. The DBCH signal receiving section 2061 feeds back the uplink CC information to the uplink transmission signal bandwidth limiting section 214 and the uplink transmission central frequency control section 215. By feeding back the uplink CC information to the uplink transmission signal bandwidth limiting section 214 and uplink transmission central frequency control section 215 in this way, it is possible to perform uplink transmission with an uplink CC forming a pair with the initial downlink CC. Furthermore, since the DBCH signal includes information (central frequency or the like) on accessible CCs, the DBCH signal receiving section 2061 extracts information of the accessible CCs from the DBCH signal and outputs the information to the downlink reception central frequency control section 201.

Furthermore, in addition to the uplink CC information forming a pair with the initial downlink CC, the DBCH signal preferably includes carrier aggregation information of the initial downlink CC (total bandwidth of aggregated CCs or number of aggregated CCs and central frequency thereof), RACH parameter specific to a mobile terminal apparatus supporting an LTE-A system and central frequency of a CC with which paging information specific to the mobile terminal apparatus supporting LTE-A is transmitted. In this case, the DBCH signal receiving section 2061 feeds back the central frequency of CCs with which carrier aggregation information and paging information are transmitted to the uplink transmission signal bandwidth limiting section 214 and the uplink transmission central frequency control section 215 and outputs the RACH parameter specific to the mobile terminal apparatus supporting an LTE-A system to the RACH signal generation section 212. By the DBCH signal receiving section 2061 feeding back the carrier aggregation information to the uplink transmission signal bandwidth limiting section 214 and uplink transmission central frequency control section 215, it is possible to transmit the uplink signal with a wide band. Furthermore, by the DBCH signal receiving section 2061 outputting the RACH parameter specific to the mobile terminal apparatus to the RACH signal generation section 212, it is possible to report as to whether or not the terminal is an LTE-A compatible terminal to the radio base station apparatus using the RACH signal. Furthermore, by feeding back the central frequency of a CC with which paging information is transmitted to the uplink transmission signal bandwidth limiting section 214 and the uplink transmission central frequency control section 215, it is possible to receive paging information in an idle mode.

The RACH response, MAC/RRC control signal receiving section 2062 receives the RACH response signal and control signal (MAC/RRC signal). Since the control signal (MAC/RRC signal) includes allocation information of a downlink CC and an uplink CC (pair band), the pair band allocation information is outputted to the pair band allocation information storage section 216. The pair band allocation information storage section 216 stores the pair band allocation information. After the pair band allocation, the pair band allocation information is used by the downlink reception central frequency control section 201, downlink received signal bandwidth extraction section 202, uplink transmission signal bandwidth limiting section 214 and uplink transmission central frequency control section 215.

The uplink shared channel signal generation section 211 generates an uplink shared channel signal using uplink transmission data from a higher layer. The uplink transmission data from the higher layer includes information (capacity information) of the transmission/reception bandwidth of the mobile terminal apparatus. By transmitting information of the transmission/reception bandwidth of the mobile terminal apparatus to the radio base station apparatus using an uplink transmission signal, the radio base station apparatus can efficiently allocate the uplink/downlink pair band.

The RACH signal generation section 212 generates an RACH signal (preamble and message). The RACH signal may also include identification information (specific signal sequence) of the LTE-A system specific to the mobile terminal apparatus supporting the LTE-A system. This makes it possible to report to the radio base station apparatus as to whether or not the terminal is an LTE-A compatible terminal using the RACH signal.

The uplink transmission signal multiplexing section 213 multiplexes the uplink control signal generated by the uplink L1/L2 control signal generation section 210, the uplink shared channel signal generated by the uplink shared channel signal generation section 211 and the RACH signal generated by the RACH signal generation section 212. The uplink transmission signal multiplexing section 213 outputs the multiplexed transmission signal to the uplink transmission signal bandwidth limiting section 214.

The uplink transmission signal bandwidth limiting section 214 places limitations on the uplink transmission signal bandwidth based on the uplink CC information (bandwidth and intermediate frequency) from the DBCH signal receiving section 2061. The transmission signal filtered in this way is sent to the uplink transmission central frequency control section 215. Furthermore, the uplink transmission signal bandwidth limiting section 214 places limitations on the uplink transmission signal bandwidth based on allocation information of the downlink CC and uplink CC. To be more specific, a transmission filter which is set to the bandwidth of the uplink CC using an uplink transmission central frequency filters the transmission signal.

The uplink transmission central frequency control section 215 controls (moves) the uplink transmission central frequency based on the uplink CC information (bandwidth and intermediate frequency) from the DBCH signal receiving section 2061. The uplink transmission central frequency control section 215 controls (moves) the uplink transmission central frequency based on the allocation information of the downlink CC and the uplink CC.

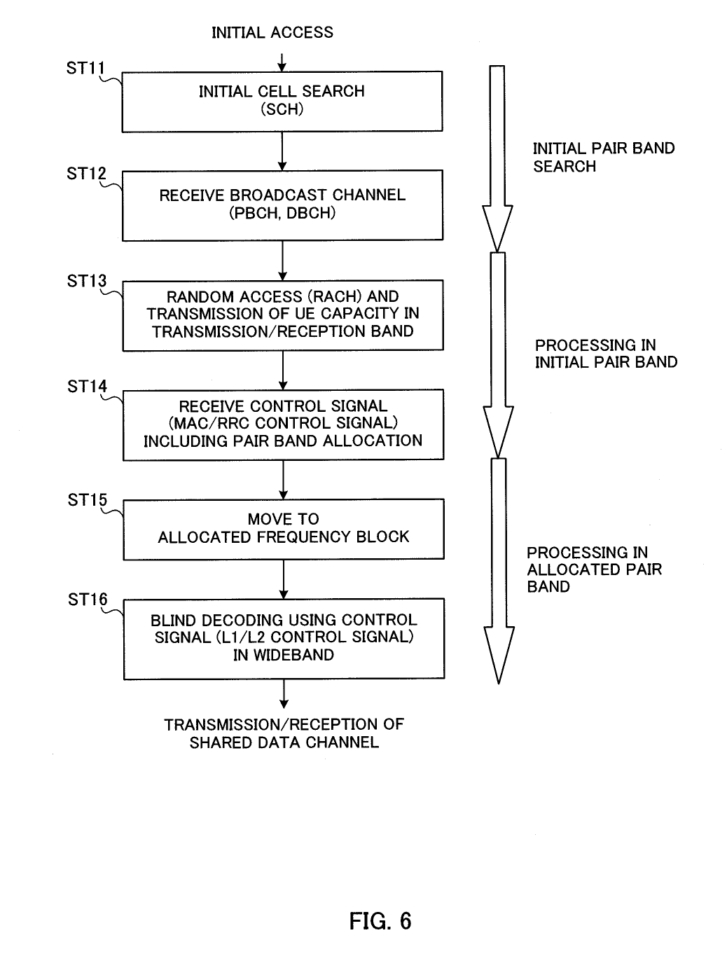

Next, a case will be described where initial access is performed between the mobile terminal apparatus and the radio base station apparatus having the above described configurations. FIG. 6 is a diagram illustrating a procedure for initial access according to the present invention. Here, the initial access procedure of mobile terminal apparatus supporting an LTE-A system will be described.

According to the initial access method of the present embodiment, the mobile terminal apparatus performs a cell search using a synchronization channel signal specific to a first mobile communication system having a relatively wide first system band composed of a plurality of component carriers multiplexed with at least one downlink component carrier in the first mobile communication system and/or a synchronization channel signal for a second mobile communication system having a relatively narrow second system band multiplexed with one downlink component carrier in the first mobile communication system and performs random access using uplink/downlink component carriers allocated based on information of downlink component carriers including the synchronization channel signal used for the cell search and information of uplink component carriers included in broadcast information broadcast from the radio base station apparatus.

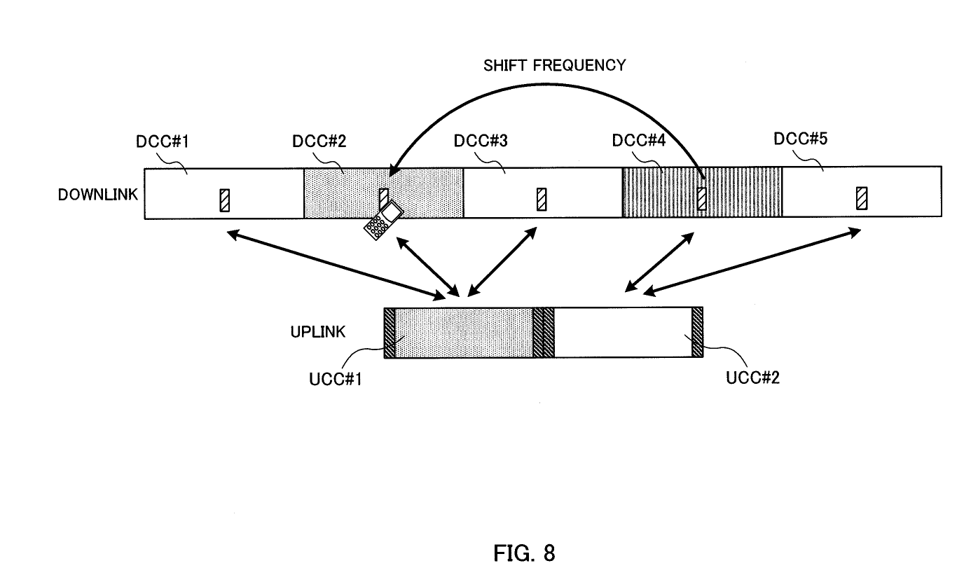

First, in the mobile terminal apparatus, the SCH signal receiving section 204 performs a cell search using an SCH signal included in one of a plurality of downlink CCs (ST11). In this case, the SCH signal receiving section 204 performs a cell search using the SCH signal A specific to an LTE-A system and/or SCH signal B for an LTE system according to an instruction from the SCH/BCH signal receiving method control section 207. The CC subjected to the cell search and connected is assumed to be an initial downlink CC. Here, downlink CC (DCC) #2 in FIG. 8 is assumed to be the initial downlink CC.

In the radio base station apparatus, the PBCH signal generation section 1012 generates a PBCH signal including information (bandwidth, number of antennas or the like) of the initial downlink CC and transmits this PBCH signal, and therefore the mobile terminal apparatus receives the PBCH signal (ST12). The DBCH signal generation section 1013 in the radio base station apparatus generates a broadcast information signal (DBCH signal) including information (bandwidth, central frequency) of the uplink CC forming a pair with the initial downlink CC and transmits this DBCH signal, and therefore the mobile terminal apparatus receives the DBCH signal (ST12). Here, as shown in FIG. 8, the uplink CC forming a pair with DCC#2 is UCC#1

In this case, the mobile terminal apparatus enables the downlink received signal bandwidth extraction section 202 to extract the bandwidth of the downlink received signal using information (bandwidth, number of antennas) of the initial downlink CC of the received PBCH signal and the downlink reception central frequency control section 201 controls the downlink reception central frequency. Furthermore, in the mobile terminal apparatus, the uplink transmission signal bandwidth limiting section 214 places limitations on the bandwidth of the uplink transmission signal using information (bandwidth, central frequency) of the uplink CC forming a pair with the initial downlink CC of the received DBCH signal and the uplink transmission central frequency control section 215 controls the uplink transmission central frequency. A pair of bands of initial downlink CC (DCC#2) and uplink CC (UCC#1) is thus determined (pair of LTE band). The initial pair band search is completed by this point.

There may also be cases where the above described mobile communication system does not transmit DBCH with all downlink CCs. In this case, when the UE cannot receive downlink CCs with which DBCH is transmitted, the aforementioned pair band cannot be determined. For this reason, when all downlink CCs do not transmit DBCH, it is preferable to broadcast information of accessible CCs through PBCH or DBCH and determine the pair band based on the information. Furthermore, the mobile communication system performs a cell search while moving from a low frequency region to a high frequency region. Therefore, when the downlink CC that receives an SCH signal is assumed to be an initial downlink CC, the initial downlink CC may be concentrated on a downlink CC of a relatively low frequency. For this reason, when all downlink CCs do not transmit DBCH, information of CCs that can receive DBCH is broadcast through PBCH and the pair band is determined based on the information. In such a case, it is also preferable to broadcast information of accessible CCs through PBCH or DBCH and determine the pair band based on the information.

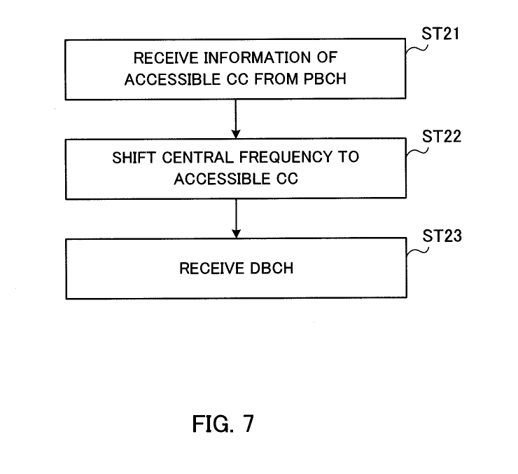

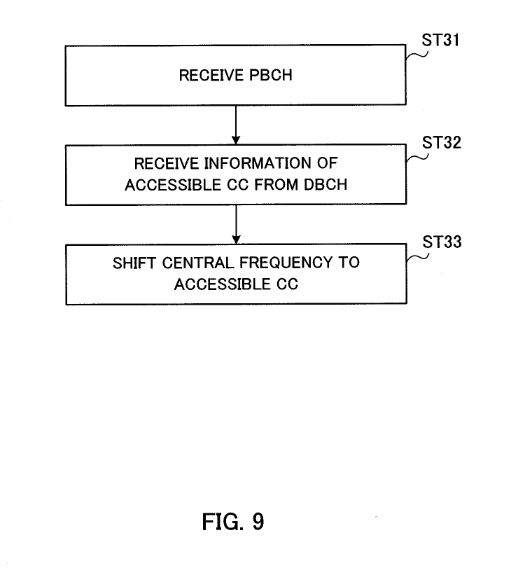

Determination of the pair band in this case will be described using FIG. 7 and FIG. 9.

According to a first method, in the mobile terminal apparatus, the SCH signal receiving section 204 performs a cell search using an SCH signal included in any one of a plurality of downlink CCs. In this case, suppose a CC for a cell search and connection is an initial downlink CC. Here, suppose downlink CC (DCC)#4 is an initial downlink CC in FIG. 8.

In the radio base station apparatus, the PBCH signal generation section 2012 generates a PBCH signal including information of the initial downlink CC (bandwidth, number of antennas, CC (accessible CC) that can receive DBCH or the like) and transmits this PBCH signal, and therefore the mobile terminal apparatus receives the PBCH signal (ST21). Here, in FIG. 8, suppose downlink CC (DCC)#2 is an accessible CC. Next, the mobile terminal apparatus moves the central frequency to the accessible CC based on the information of the CC broadcast through PBCH (ST22).

Next, the mobile terminal apparatus receives the DBCH signal of accessible CC (ST23) and places limitations on the bandwidth of the uplink transmission signal through the uplink transmission signal bandwidth limiting section 114 using the information (bandwidth, central frequency) of the uplink CC forming a pair with the initial downlink CC and controls the uplink transmission central frequency through the uplink transmission central frequency control section 115. The mobile terminal apparatus thereby determines a pair band of the accessible downlink CC (DCC#2) and uplink CC (UCC#1) (LTE pair band). The initial pair band search is completed by this point. This allows the pair band to be determined even when DBCH is not transmitted with all downlink CCs. According to such a cell search, the central frequency is moved to the accessible CC before receiving DBCH and it is thereby possible to speedily determine a pair band.

Next, according to a second method, the mobile terminal apparatus performs a cell search through the SCH signal receiving section 204 using an SCH signal included in any one of a plurality of downlink CCs. In this case, suppose the CC for a cell search and connection is an initial downlink CC. Here, suppose downlink CC (DCC)#4 in FIG. 8 is an initial downlink CC.

The radio base station apparatus generates, through the PBCH signal generation section 2012, a PBCH signal including information (bandwidth, number of antennas or the like) of an initial downlink CC and transmits this PBCH signal, and therefore the mobile terminal apparatus receives the PBCH signal (ST31). Next, the mobile terminal apparatus receives a DBCH signal. In this method, since the DBCH signal includes information of accessible CCs, the mobile terminal apparatus receives the DBCH signal, and can thereby recognize the accessible CCs (ST32). Here, suppose downlink CC (DCC) #2 is an accessible CC in FIG. 8. Next, the mobile terminal apparatus shifts the central frequency to the accessible CC based on the information of the accessible CC broadcast through DBCH (ST33). The mobile terminal apparatus places limitations on the bandwidth of the uplink transmission signal through the uplink transmission signal bandwidth limiting section 114 using information (bandwidth, central frequency) of the uplink CC forming a pair with the initial downlink CC and controls the uplink transmission central frequency through the uplink transmission central frequency control section 115. The pair band of the accessible downlink CC (DCC#2) and uplink CC (UCC#1) is thereby determined (LTE pair band). The initial pair band search is completed by this point. This allows the pair band to be determined even when DBCH is not transmitted with all downlink CCs. According to such a cell search, since the PBCH signal does not include information of the accessible CCs, it is possible to prevent overhead of the PBCH signal from increasing.

Furthermore, the radio base station apparatus generates, through the DBCH signal generation section 1013, a broadcast information signal (DBCH signal) including an RACH parameter that can identify whether or not the terminal is an LTE-A terminal and transmits this DBCH signal, and therefore the mobile terminal apparatus receives the DBCH signal. The mobile terminal apparatus generates, through the RACH signal generation section 212, an RACH signal based on the received RACH parameter and transmits the RACH signal to the radio base station apparatus using the uplink CC (UCC#1) (random access) (ST13).

In the radio base station apparatus, when the uplink CCRACH signal receiving section (here, UCC#1 RACH signal receiving section) 110 receives the RACH signal, the RACH response signal, MAC/RRC control signal generation section 1014 generates an RACH response signal and transmits the RACH response signal to the mobile terminal apparatus through the initial downlink CC (DCC#2). After receiving the RACH response signal, the mobile terminal apparatus generates an uplink shared channel signal through the uplink shared channel signal generation section 211 and transmits the uplink shared channel signal to the radio base station apparatus through the PUSCH (Physical Uplink Shared Channel) of the uplink CC (UCC#1). In this case, the uplink shared channel includes information (UE capacity information) of the transmission/reception bandwidth of the mobile terminal apparatus and the UE capacity information is reported to the radio base station apparatus (ST13).

Furthermore, the mobile terminal apparatus generates an uplink shared channel signal including the UE capacity information (information of transmission/reception bandwidth of the mobile terminal apparatus) through the uplink shared channel signal generation section 211 and transmits the uplink shared channel signal to the radio base station apparatus using the uplink CC (UCC#1) (ST13). Upon receiving the uplink shared channel signal through the uplink shared channel signal receiving section 109, the radio base station apparatus sends the UE capacity information to the pair band allocation control section 111. Upon receiving the UE capacity information, the pair band allocation information control section 111 allocates a pair band of uplink/downlink CCs based on the UE capacity (here bandwidths corresponding to two CCs (40 MHz)). Here, as shown in FIG. 8, the uplink includes UCC#1 and UCC#2 and the downlink includes DCC#1, DCC#2 and DCC#3. The pair band allocation control section 111 sends the pair band allocation information to the shared channel scheduler 112. The shared channel scheduler 112 schedules the uplink/downlink control signal and uplink/downlink shared channel signal using pair band allocation information. Furthermore, the radio base station apparatus generates a control signal (MAC/RRC control signal) through the RACH response signal, MAC/RRC control signal generation section 1014 and transmits the control signal to the mobile terminal apparatus using the PDSCH (Physical Downlink Shared Channel) of this downlink CC (DCC#2). In this case, the control signal (MAC/RRC control signal) includes pair band allocation information and this band allocation information is reported to the mobile terminal apparatus (ST14). The processing in the initial pair band is completed by this point.

Next, processing is performed using the allocated pair band. Upon receiving a control signal including the pair band allocation information through the RACH response signal, MAC/RRC control signal receiving section 2062, the mobile terminal apparatus sends this pair band allocation information to the pair band allocation information storage section 216 and stores the pair band allocation information therein. This pair band allocation information is sent to the downlink received signal bandwidth extraction section 202, downlink reception central frequency control section 201, uplink transmission signal bandwidth limiting section 214 and uplink transmission central frequency control section 215, and the frequency is adjusted (shifted) based on the pair band allocated by each processing section (ST15). To be more specific, the downlink reception central frequency control section 201 adjusts the frequency to the central frequency of the bandwidth (aggregated CCs) of the downlink CCs (DCC#1, DCC#2, DCC#3) and the downlink received signal bandwidth extraction section 202 extracts the downlink received signal with the bandwidths of the downlink CCs (DCC#1, DCC#2, DCC#3). The uplink transmission central frequency control section 215 adjusts the frequency to the central frequency of the bandwidth (aggregated CCs) of the uplink CCs (UCC#1, UCC#2), the uplink transmission signal bandwidth limiting section 214 limits the uplink transmission signal to the bandwidths of the uplink CCs (UCC#1,UCC#2). Thus, the mobile terminal apparatus communicates with the radio base station apparatus using the allocated wide frequency band. After that, the mobile terminal apparatus receives the downlink control information (L1/L2 control signal), verifies a user ID and decodes radio resource allocation information corresponding to the user ID (blind decoding) (ST16). After that, the mobile terminal apparatus transmits/receives a shared data channel.

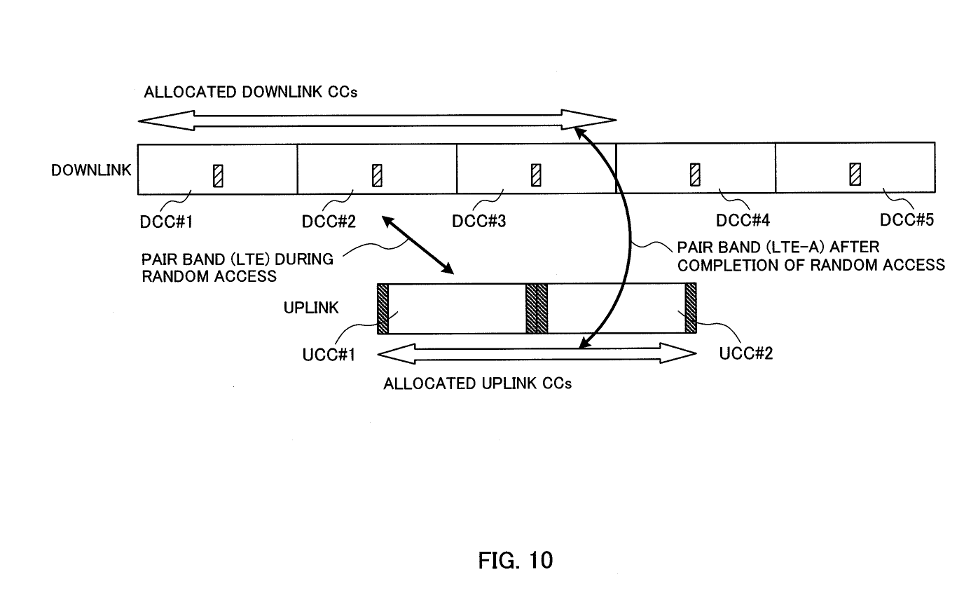

As shown in FIG. 10, a pair band (DCC#2-UCC#1) is confirmed during random access as with the LTE system, and UE capacity information and pair band allocation information are transmitted/received to confirm pair bands (DCC#1, DCC#2, DCC#3-UCC#1, UCC#2) allocated to a wideband using the pair band. For this reason, when a plurality of mobile communication systems (LTE system and LTE-A system) coexist, it is possible to make initial access in accordance with the respective mobile communication systems.

A mobile terminal apparatus supporting an LTE system cannot detect SCH or PBCH specific to an LTE-A system (or cannot detect SCH or PBCH because SCH or PBCH is not transmitted with CCs), and therefore the terminal apparatus performs a cell search using only SCH for an LTE system. This allows the mobile terminal apparatus supporting an LTE system to make initial access using desired CCs.

The present invention thus adopts a transmission method of transmitting SCH (PBCH) specific to an LTE-A system using a downlink CC and transmitting SCH (PBCH) for an LTE system using another downlink CC or a transmission method of not transmitting SCH (PBCH) using a certain CC but transmitting SCH (PBCH) for an LTE system using another downlink CC. In this case, SCH (PBCH) for an LTE system is multiplexed with a downlink CC whereby it is desirable to make initial access to a mobile terminal apparatus supporting an LTE system. The mobile terminal apparatus supporting an LTE system cannot make initial access with downlink CCs with which SCH (PBCH) specific to an LTE-A system is multiplexed or with downlink CCs with which SCH (PBCH) is not multiplexed, and thus necessarily makes initial access with CCs with which SCH (PBCH) for an LTE system is multiplexed. Since a CC with which initial access is made is a CC with which it is desirable to make initial access to a mobile terminal apparatus supporting an LTE system, it is not necessary to shift a frequency from a CC detected by a cell search to a different CC in a stage at which communication starts. When an LTE-A system and an LTE system coexist, it is possible to reduce a control delay between the radio base station apparatus and mobile terminal apparatus in consequence. Furthermore, the present invention makes it unnecessary to report control information for moving CCs to the mobile terminal apparatus (or can reduce control information even if the reporting is necessary), and can thereby reduce the amount of overhead of control information. The present invention is more likely to allow a cell search time to be reduced compared to the method of reporting control information for moving CCs.

The present invention is not limited to the above described embodiment, but may be implemented modified in various ways. For example, the invention can be implemented by modifying the above described allocation of component carriers, number of processing sections, processing procedure, number of component carriers and number of aggregated component carriers as appropriate without departing from the scope of the present invention. Other elements of the present invention may also be implemented modified as appropriate without departing from the scope of the present invention.

1. A radio base station apparatus comprising:
synchronization channel signal generating section configured to generate, for at least one downlink component carrier in a first mobile communication system having a relatively wide first system band composed of a plurality of component carriers, a synchronization channel signal specific to the first mobile communication system and generate a synchronization channel signal for a second mobile communication system having a relatively narrow second system band for an other downlink component carrier with which the synchronization channel signal specific to the first mobile communication system is not multiplexed; and
transmitting section configured to transmit a control signal including the synchronization channel signal.

2. The radio base station apparatus according to claim 1, wherein the synchronization channel signal specific to the first mobile communication system cannot be used for cell search on a mobile terminal apparatus supporting the second mobile communication system.

3. The radio base station apparatus according to claim 1, further comprising physical broadcast channel signal generating section configured to generate a physical broadcast channel signal specific to the first mobile communication system for at least one downlink component carrier in the first mobile communication system and generate a physical broadcast channel signal for a second mobile communication system having a relatively narrow second system band for the other downlink component carrier with which a physical broadcast channel signal specific to the first mobile communication system is not multiplexed.

4. A radio base station apparatus comprising:
synchronization channel signal generating section configured to generate, for at least one downlink component carrier in a first mobile communication system having a relatively wide first system band composed of a plurality of component carriers, a synchronization channel signal for a second mobile communication system having a relatively narrow second system band and generate no synchronization channel signal for other downlink component carriers; and
transmitting section configured to transmit a control signal including the synchronization channel signal.

5. The radio base station apparatus according to claim 4, further comprising physical broadcast channel generating section configured to generate a physical broadcast channel signal for a second mobile communication system having a relatively narrow second system band for at least one downlink component carrier in the first mobile communication system and generate no physical broadcast channel signal for other downlink component carriers.

6. The radio base station apparatus according to claim 1, further comprising control signal allocating section configured to allocate the downlink component carrier with which the synchronization channel signal specific to the first mobile communication system and/or physical broadcast channel signal are/is multiplexed or allocate the other downlink component carrier with which the synchronization channel signal and/or physical broadcast channel signal are/is not multiplexed.

7. The radio base station apparatus according to claim 6, wherein the control signal allocating section allocates the synchronization channel signal and/or physical broadcast channel signal to the downlink component carrier based on at least one selected from a group of the number of connected mobile terminals in each component carrier, amount of interference power in each component carrier, amount of data load in each component carrier and path loss between the radio base station apparatus and the mobile terminal apparatus.

8. The radio base station apparatus according to claim 3, wherein the physical broadcast channel signal generating section generates a physical broadcast channel signal including information of an accessible component carrier that can receive a dynamic broadcast channel signal.

9. The radio base station apparatus according to claim 1, further comprising dynamic broadcast channel signal generating section configured to generate a dynamic broadcast channel signal including information of accessible component carriers.

10. A mobile terminal apparatus comprising:
cell search section configured to perform a cell search using a synchronization channel signal specific to a first mobile communication system having a relatively wide first system band composed of a plurality of component carriers, which the synchronization channel signal specific to a first mobile communication system is multiplexed with at least one downlink component carrier in the first mobile communication system; and
central frequency controlling section configured to control a reception central frequency of a downlink signal based on information of the downlink component carrier including the cell-searched synchronization channel signal specific to the first mobile communication system.

11. A mobile terminal apparatus comprising:
cell search section configured to perform a cell search using a synchronization channel signal for a second mobile communication system having a relatively narrow second system band, which the synchronization channel signal for a second mobile communication system is multiplexed with at least one downlink component carrier in a first mobile communication system having a relatively wide first system band composed of a plurality of component carriers; and
central frequency controlling section configured to control a reception central frequency of a downlink signal based on information of a downlink component carrier including the cell-searched synchronization channel signal for the second mobile communication system.

12. The mobile terminal apparatus according to claim 10, wherein the cell search section performs a cell search using a synchronization channel signal specific to the first mobile communication system and a synchronization channel signal for the second mobile communication system.

13. The mobile terminal apparatus according to claim 10, further comprising physical broadcast channel signal receiving section configured to receive a physical broadcast channel signal specific to the first mobile communication system multiplexed with at least one downlink component carrier in the first mobile communication system and/or a physical broadcast channel signal for a second mobile communication system having a relatively narrow second system band multiplexed with at least one downlink component carrier in the first mobile communication system.

14. The mobile terminal apparatus according to claim 13, wherein the physical broadcast channel signal receiving section receives a physical broadcast channel signal including information of accessible component carriers that can receive a dynamic broadcast channel signal, and
the received central frequency controlling section controls a received central frequency of the downlink signal based on the information of the accessible component carriers.

15. The mobile terminal apparatus according to claim 10, further comprising dynamic broadcast channel signal receiving section configured to receive a dynamic broadcast channel signal including information of accessible component carriers,
wherein the received central frequency controlling section controls the received central frequency of the downlink signal based on the information of the accessible component carriers.

16. An initial access method in a mobile terminal apparatus comprising the steps of:
performing a cell search using a synchronization channel signal, specific to a first mobile communication system having a relatively wide first system band comprising a plurality of component carriers, multiplexed with at least one downlink component carrier in the first mobile communication system and/or a synchronization channel signal, for a second mobile communication system having a relatively narrow second system band, multiplexed with at least one downlink component carrier in the first mobile communication system; and
performing random access using uplink/downlink component carriers allocated based on information of downlink component carriers including the synchronization channel signal used for the cell search and information of uplink component carriers included in a dynamic broadcast channel signal broadcast from a radio base station apparatus.

17. The initial access method in a mobile terminal apparatus according to claim 16, wherein the radio base station apparatus transmits a physical broadcast channel signal including information of accessible component carriers that can receive the dynamic broadcast channel signal, and
the mobile terminal apparatus controls a received central frequency of a downlink signal based on the information of the accessible component carriers.

18. The initial access method in a mobile terminal apparatus according to claim 16, wherein the radio base station apparatus transmits a dynamic broadcast channel signal including information of accessible component carriers, and
the mobile terminal apparatus controls a received central frequency of a downlink signal based on the information of the accessible component carriers.

19. The radio base station apparatus according to claim 5, wherein the physical broadcast channel signal generating section generates a physical broadcast channel signal including information of an accessible component carrier that can receive a dynamic broadcast channel signal.

20. The mobile terminal apparatus according to claim 11, further comprising physical broadcast channel signal receiving section configured to receive a physical broadcast channel signal specific to the first mobile communication system multiplexed with at least one downlink component carrier in the first mobile communication system and/or a physical broadcast channel signal for a second mobile communication system having a relatively narrow second system band multiplexed with at least one downlink component carrier in the first mobile communication system.
